(19) United States
(12) Patent Application Publication
(10) Pub. No.: US 2008/0115411 A1
(43) Pub. Date: May 22, 2008

(54) Weed control system

(76) Inventor: Philip W. Ramsey, Missoula, MT (US)

Correspondence Address: PETER J. VAN BERGEN, ESQ., 402 West Duke of Gloucester St., Williamsburg, VA, 23185, US

(21) Appl. No.: 11/600,949

(22) Filed: Nov. 16, 2006

(51) Int. Cl. A01G 13/02; A01N 43/32; A01N 43/54

(52) U.S. Cl. 47/20.1; 504/297; 504/241; 47/32.3

(57) ABSTRACT

A weed control system has an opaque portion and a growth promoting portion. The opaque portion blocks passage of light therethrough and blocks passage of seedlings growing from weed seeds in a ground region. The growth promoting portion is adapted to be disposed between the opaque portion of the system and the ground region. The growth promoting portion promotes germination of the weed seeds and the resulting weed seedlings die as the opaque portion prevents any light from reaching the seedlings.

### FIELD OF THE INVENTION

The invention relates generally to weed control, and more particularly to a weed control system that promotes weed seed germination and subsequently kills the weed seedlings.

### BACKGROUND OF THE INVENTION

Invasive exotic plants are a large problem in the United States as they cause billions of dollars in damages each year. The control of exotic species is a major challenge to biologists and a major drain on the resources of land-owners. The most effective way to control weed infestations is to aggressively fight small infestations as they are discovered so that the weed can not become widely established on a property. Small infestations usually occur along roadsides, trailheads, and parking areas where seeds are transported by the undercarriage and tires of vehicles. Small infestations also occur along the leading edge of large infestations. Many weed species greatly reduce the diversity of local flora occurring in a given location.

When landowners and land managers observe new weed infestations on their properties they initiate activities designed to control the spread of the weed and to eradicate it. These activities may consist of hand pulling the weeds, mowing the flowers off the weeds, or spraying the weeds with herbicides. However, the control of weed infestations using herbicide applications also reduces flora diversity because non-target plants are killed along with the undesirable weed. Herbicide application to a given area is imprecise because wind tends to blow the herbicide off of the targeted area and into non-target areas where the vegetation may be sensitive to the herbicide.

Using current weed control methodologies, eradication of weeds in infested areas may take years of persistent effort because seeds remaining in the soil or on the soil surface continue to germinate after the adult plants are killed. Seeds are often abundant because they have accumulated at the start of the infestation until the initiation of a management action. Killing all of the seedlings by a method such as hand pulling is difficult and labor intensive.

One exotic, invasive, and pervasive weed of great concern is Centaurea maculosa (or “spotted knapweed” as it is typically called). Spotted knapweed originated from Eurasia, but now infests grasslands, rangelands, areas recently burned by forest fires, and areas disturbed by construction activities such as road building across the United States. Areas heavily infested with knapweed suffer from reduced native plant productivity as biodiversity can be reduced by more than 90%. Knapweed avoids competition with con-specific plants by secreting a compound known as racemic catechin which inhibits the germination of knapweed seeds. Germination inhibition allows knapweed plants to self-regulate the density of knapweed plants in an area. That is, knapweed seeds that would otherwise sprout and have to compete with adult plants, wait in the soil in a “seed bank” until the adult knapweed pants die. The knapweed seeds are then free to germinate in a competition free environment. Knapweed control by manual pulling of the adult plants, timed mowing of the adult plants, grazing of the adult plants, and herbicide application to the adult plants, is not a long-term solution to knapweed infestation because knapweed seeds remaining in the soil germinate after the weed control “treatment” and replace the knapweed plants that have been removed.

### SUMMARY OF THE INVENTION

Accordingly, it is an object of the present invention to provide a weed control system.

Another object of the present invention is to provide a herbicide free control system.

Still another object of the present invention is to provide a weed control system that offers a long-term solution to knapweed infestation.

Other objects and advantages of the present invention will become more obvious hereinafter in the specification and drawings.

In accordance with the present invention, a weed control system has an opaque portion adapted to cover a ground region infested with weed seeds. The opaque portion blocks passage of light therethrough and blocks passage of seedlings growing from the weed seeds and up from the ground region. The system also has a growth promoting portion adapted to be disposed between the opaque portion of the system and the ground region. The growth promoting portion promotes germination of the weed seeds. The resulting weed seedlings die as the opaque portion prevents any light from reaching the seedlings.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a schematic view of a weed control system deployed on a ground region in accordance with the present invention;

FIG. 2 is a schematic view of an embodiment of the weed control system in which particles of a growth promoting material are coupled directly to the surface of an opaque sheet;

FIG. 3 is a schematic view of another embodiment of the weed control system in which particles of a growth promoting material are impregnated in a carrier that is attached to the surface of an opaque sheet;

FIG. 4A is a schematic view of a ground region infested with adult Centaurea maculosa plants and Centaurea maculosa seeds;

FIG. 4B is a schematic view of the ground region in FIG. 4A after the adult Centaurea maculosa plants have been reduced in height;

FIG. 4C is a schematic view of the ground region with the reduced-height Centaurea maculosa plants covered by the weed control system of the present invention; and

FIG. 5 is a schematic view of a weed control system that uses two types of weed seed germination promoters in accordance with another embodiment of the present invention.

### DETAILED DESCRIPTION OF THE INVENTION

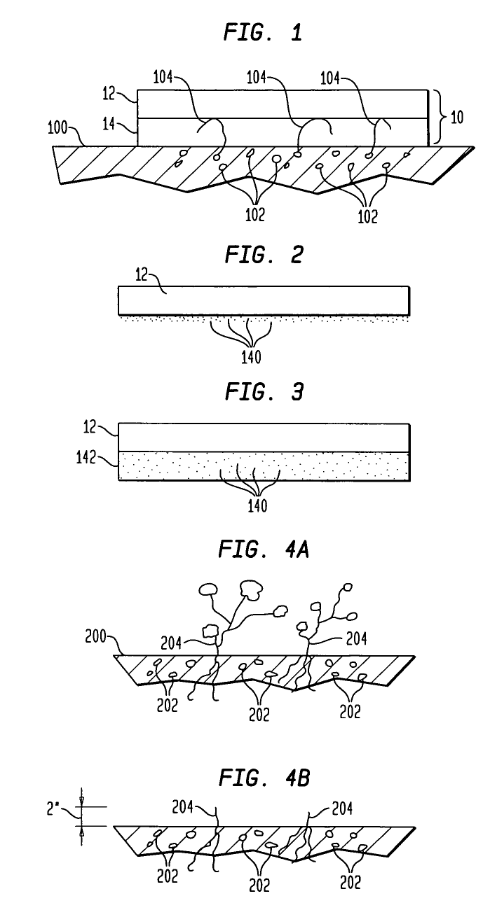

Referring now to the drawings and more particularly to FIG. 1, a weed control system 10 in accordance with the present invention is illustrated as it would be deployed on a ground region 100. For purpose of illustrating the present invention, ground region 100 is infested with the weed seeds 102, some of which may have germinated and sprouted seedlings 104 growing upward from ground region 100. As will be explained further below, weed control system 10 operates to reduce the number of seeds 102 in ground region 100 as a means to greatly reduce or eliminate the growth of an adult population of weeds stemming from weed seeds 102. Weed control system 10 can be implemented by a variety of constructions thereof without departing from the scope of the present invention. However, regardless of the particular construction, the basic principles governing weed control system 10 will be the same for a variety of types of weeds/weed seeds.

Weed control system 10 is essentially a two-part or layered system defined generally by (i) a top part 12 that is both opaque and strong, and (ii) a bottom part 14 that will promote germination of weed seeds 102. More specifically, top part 12 is typically a flexible sheet of light blocking material that can be readily deployed to cover and be secured to (e.g., staked, weighted, etc.) the relevant area of ground region 100. At the same time, top part 12 must be strong enough to prevent weed seedlings 104 from poking therethrough when seedlings 104 grow up from ground region 100. In this way, weed seedlings 104 cannot receive light when emerging from ground region 100 and will, therefore, die in a relatively short period of time. In order to prevent weed seeds 102 from lying dormant in ground region 100, bottom part 14 serves to promote germination of weed seeds 102 to thereby convert most or all of weed seeds 102 to weed seedlings 104 which will be killed when they emerge from ground region 100. This reduces or eliminates the weed seed population and, further, prevents re-population by more weed seeds since no adult weed plants are allowed to grow and deposit a new crop of weed seeds.

Bottom part 14 of weed control system 10 is typically a particle form (e.g., powder, pellets, etc.) of a material that will promote the growth of weed seeds 102. The particular material used can depend on the type of weed/weed seed population that is to be controlled. For example, if the particular type of weed seeds can have the germination thereof directly promoted, the germination material used in bottom part 14 can be a well-known growth enhancer such as gibberellic acid or kinetin. However, as will be explained further below, some weed species employ mechanisms that would inhibit germination. In such instances, the material used in bottom part 14 could be chosen to disable the particular weed species mechanism that inhibited germination. For example, in the case of the pervasive weed Centaurea maculosa (also known as “spotted knapweed”), adult weeds secrete racemic catechin which inhibits germination of the Centaurea maculosa seeds. In this instance, activated carbon can be used to adsorb the racemic catechin to effectively disable the weed germination inhibition mechanism as will be explained further below.

Regardless of the type of weed germination promoter(s) used in bottom part 14, the particlized form of the material can be coupled to top part 12 in a variety of ways. For example, in FIG. 2, particles 140 are coupled directly to a surface of top part 12 that will face ground region 100. Such direct coupling of a particlized material to a sheet of material (i.e., top part 12) can be accomplished in a variety of ways known in the art and is not a limitation of the present invention. Particles 140 would typically be kept dry prior to deployment of the weed control system but would be carried away from top part 12 and absorbed into a ground region as ground moisture came into contact therewith.

Particles 140 could also be supported in a carrier as shown in FIG. 3 where particles 140 are impregnated in a carrier 142 that is attached to a surface of top part 12. Carrier 142 is typically an inert material that will allow particles 140 to be released therefrom once the weed control system is deployed. For example, carrier 142 could be a woven, knitted, or felted fabric that reasonably supported particles 140 in interstices of the fabric. Particles 140 could then be carried away from carrier 142 by ground moisture. Carrier 142 could also be a biodegradable material (e.g., a wax, starch, cellulose, or other carbohydrate-based material, etc.) that breaks down over time in the environment of a ground region.

As mentioned above, top part 12 must be opaque and strong enough to prevent “poke through” by weed seedlings. However, top part 12 can be impervious to the passage of moisture or moisture permeable without departing from the scope of the present invention. Note that moisture permeability may be desired to facilitate the release of particles 140 (from either top part 12 or carrier 142). It is to be understood that such moisture permeability is to be achieved for top part 12 without negating its ability to block light and prevent seedling “poke through”.

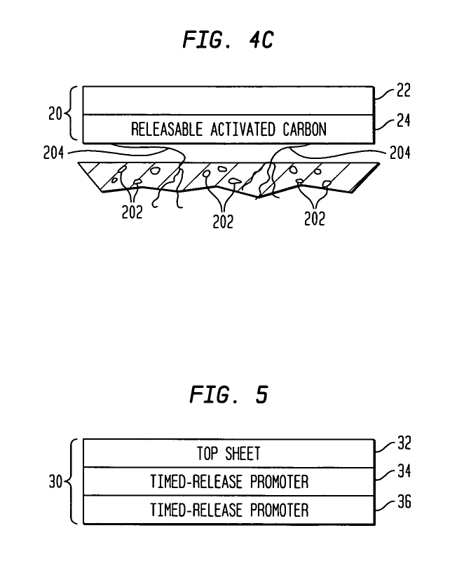

By way of illustrative example, an embodiment of the present invention, can be configured for the control of the exotic weed Centaurea maculosa. As previously explained, adult Centaurea maculosa plants secrete racemic catechin into the surrounding ground region to inhibit germination of Centaurea maculosa seeds in the same region. Control of this particular weed using the present invention's weed control system will be explained with the aid of FIGS. 4A-4C.

FIG. 4A is a schematic representation of a ground region 200 that is infested with both Centaurea maculosa weed seeds 202 and adult Centaurea maculosa plants 204 which secrete racemic catechin (not shown) into ground region 200. Prior to placing the weed control system of the present invention on ground region 200, plants 204 must be reduced in height. Typically, plants 204 are reduced to a height of approximately 2″ or less as depicted in FIG. 4B. Such plant height reduction can be achieved in a variety of ways without departing from the scope of the present invention. For example, plant height reduction can be achieved by pulling out the adult plants, cutting the adult plants using hand-operated or mechanized tools (e.g., mowers), or through the use of grazing animals (e.g., sheep).

Once the adult plants (i.e., both Centaurea maculosa plants and other vegetation) in ground region 200 have been reduced in height, the weed control system of the present invention is placed on and secured to ground region 200. In FIG. 4C, weed control system 20 includes a top sheet 22 of opaque material that is strong enough to prevent passage of both adult Centaurea maculosa plants 204 and seedlings growing upward from Centaurea maculosa seeds 202 after seeds 202 germinate. If weed control system 20 is subject to traffic by local wildlife (e.g., deer), top sheet 22 should also be strong enough to withstand such traffic. Coupled to one side (i.e., the side facing ground region 200) of top sheet 22 is a releasably supported form of activated carbon 24 (e.g., particles of activated carbon applied directly to top sheet 22 or supported within a carrier as previously described). Accordingly, top sheet 22 can be impervious to water or water permeable as needed to facilitate the release of the activated carbon. In operation, once the activated carbon is released into ground region 200, the activated carbon will adsorb racemic catechin so that weed seeds 202 are able to germinate even while adult Centaurea maculosa plants 204 are alive. The opaque and puncture-proof nature of top sheet 22 will then serve to kill both plants 204 and seedlings growing from seeds 202 as light is prevented from reaching them.

The present invention could also make use of more than one type of weed seed germination promoter. For example, the weed seed promoters could function differently and be time-released so that each promoter's operating mechanism optimized the weed control results. By way of example, a multiple promoter system is illustrated in FIG. 5. Specifically, a weed seed control system 30 could include a top sheet 32 with two timed-release promoter layers 34 and 36 where each of promoters 34 and 36 was released at a different time and operated differently. For example, if a ground region had adult Centaurea maculosa plants and Centaurea maculosa seeds, promoter 36 could be activated carbon designed to be released into the ground region first to adsorb racemic catechin. Then, if promoter 34 were a growth enhancer (e.g., gibberellic acid, kinetin, etc.) released into the ground region some time after promoter 36 was released, germination of the weed seeds could proceed at a faster pace as compared to weed control systems that relied totally on activated carbon.

The advantages of the present invention are numerous. Long-lasting weed control is achieved as the weed seed population is both greatly reduced and prevented from being re-populated. No spraying of herbicides is required. Indeed, no herbicides of any kind are required. The present invention is an entirely new approach to weed control that operates to eliminate both adult weeds while reducing/eliminating the weed seed population in a treated region.

Although the invention has been described relative to a specific embodiment thereof, there are numerous variations and modifications that will be readily apparent to those skilled in the art in light of the above teachings. It is therefore to be understood that, within the scope of the appended claims, the invention may be practiced other than as specifically described.

What is claimed as new and desired to be secured by Letters Patent of the United States is:

1. A weed control system, comprising:
opaque means adapted to cover a ground region infested with weed seeds, said opaque means blocking passage of light therethrough and blocking passage of seedlings growing from the weed seeds and up from the ground region; and
growth promoting means adapted to be disposed between said opaque means and the ground region for promoting germination of the weed seeds.

2-4. (canceled)

5. A weed control system as in claim 1 wherein said growth promoting means is selected from the group consisting of at least one of activated carbon, gibberellic acid and kinetin.

6. A weed control system as in claim 1 wherein said growth promoting means is coupled to a surface of said opaque means.

7. A weed control system as in claim 1 wherein said growth promoting means comprises a carrier supporting particles therein of activated carbon.

8. A weed control system as in claim 7 wherein said carrier is coupled to a surface of said opaque means.

9. A weed control system as in claim 1 wherein said growth promoting means comprises a carrier supporting particles therein of a material selected from the group consisting of gibberellic acid and kinetin.

10. A weed control system as in claim 9 wherein said carrier is coupled to a surface of said opaque means.

11. A weed control system, comprising:
a sheet of opaque material adapted to cover a ground region infested with weed seeds, said sheet blocking passage of light therethrough and blocking passage of seedlings growing from the weed seeds and up from the ground region; and
a carrier impregnated with particles of a material that promote germination of the weed seeds when said particles are in contact with the ground region, said carrier adapted to be disposed between said sheet and the ground region and in contact with the ground region.

12. A weed control system as in claim 11 wherein said sheet is coupled to said carrier.

13-14. (canceled)

15. A weed control system as in claim 12, wherein said particles are selected from the group consisting of at least one of activated carbon, gibberellic acid and kinetin.

16. A weed control system as in claim 11 wherein said carrier is selected from the group consisting of a fabric, a carbohydrate-based material, and wax.

17. A weed control system, comprising:
a sheet of opaque material adapted to cover a ground region infested with (i) Centaurea maculosa seeds, and (ii) adult Centaurea maculosa plants that have been reduced to a height not to exceed approximately two inches wherein the adult Centaurea maculosa plants release racemic catechin into the ground region, said sheet blocking passage of light therethrough and preventing penetration by (i) Centaurea maculosa seedlings growing upward from the Centaurea maculosa seeds, and (ii) the adult Centaurea maculosa plants; and
activated carbon releasably supported on a surface of said sheet and disposed between said sheet and the ground region in a quantity sufficient to adsorb the racemic catechin in the ground region so-covered when said activated carbon is released onto the ground region.

18. A weed control system as in claim 17 wherein said activated carbon is in the form of particles thereof.

19. A weed control system as in claim 17 wherein said activated carbon is coupled directly to said surface of said sheet.

20. A weed control system as in claim 18 further comprising a carrier coupled to said surface of said sheet and impregnated with said particles of said activated carbon.

21. A weed control system as in claim 20 wherein said sheet prevents passage of moisture therethrough.

22. A weed control system as in claim 20 wherein said sheet permits passage of moisture therethrough.

23. A weed control system as in claim 20 wherein said carrier is selected from the group consisting of a fabric, a carbohydrate-based material, and wax.

24. A method of reducing the number of Centaurea maculosa seeds in a ground region in which adult Centaurea maculosa plants are present and releasing racemic catechin in the ground region, comprising the steps of:
reducing the adult Centaurea maculosa plants to a height not to exceed approximately two inches;
providing a sheet of opaque material with activated carbon releasably supported on a surface thereof in a quantity sufficient to adsorb the racemic catechin in the ground region when said activated carbon is released onto the ground region; and
securing said sheet to the ground region with said surface thereof facing the ground region wherein said sheet blocks passage of light therethrough and prevents penetration by (i) Centaurea maculosa seedlings growing upward from the Centaurea maculosa seeds, and (ii) the adult Centaurea maculosa plants.

25. A method according to claim 24 wherein said step of reducing comprises the step of cutting of the adult Centaurea maculosa plants to a height not to exceed approximately two inches.

26. A method according to claim 24 wherein said step of reducing comprises the step of permitting animal grazing of the adult Centaurea maculosa plants until they attain a height not to exceed approximately two inches.

27. A method according, to claim 24 wherein said activated carbon comprises particles thereof coupled directly to said surface.

28. A method according to claim 24 wherein said activated carbon comprises particles thereof impregnated in a carrier coupled to said surface.

29. A method according to claim 24 wherein said sheet prevents passage of moisture therethrough.

30. A method according to claim 24 wherein said sheet permits passage of moisture therethrough.
